(19) United States
(12) Patent Application Publication
(10) Pub. No.: US 2007/0269670 A1
(43) Pub. Date: Nov. 22, 2007

(54) Multilayered structures and their use as optical storage media

(76) Inventors: Ronald Wilmer, Hoeilaazt (BE); David R. Foss, Chesapeake, VA (US)

Correspondence Address: NOVA Chemicals Inc., Westpointe Center, 1550 Coraopolis Heights Road, Moon Township, PA, 15108, US

(21) Appl. No.: 11/796,872

(22) Filed: Apr. 30, 2007

Related U.S. Application Data
(60) Provisional application No. 60/801,163, filed on May 17, 2006.

(51) Int. Cl. B32B 27/00; B32B 27/30; B32B 27/32

(52) U.S. Cl. 428/500; 428/800; 428/522; 428/521

(57) ABSTRACT

A multilayer structure that includes a substrate layer containing a mixture containing one or more copolymers that include polymerized residues from one or more styrenic monomers and one or more C₁-C₃₂ linear, branched, or cyclic alkyl(meth)acrylate monomers and/or maleic-type monomers and one or more elastomeric materials; and a reflective film layer coated on a surface of the substrate layer. The multilayer structure can be used as an optical storage medium.

This application claims the benefit of priority of U.S. Provisional Application Ser. No. 60/801,163, filed May 17, 2006, entitled “Multilayered Structures and Their Use as Optical Storage Media”.

### BACKGROUND OF THE INVENTION

1. Field of the Invention

The present invention is directed to multilayered structures that can include reflective layers or semi-reflective layers, which can be useful as optical storage media.

2. Description of the Prior Art

The compact disc (CD) has become the standard for high-speed, high-capacity Read Only Memory (ROM). In addition, there are also recordable (CD-R) and rewritable (CD-RW) CD technologies available. Advances in CD technology have increased both the speed of data transfer and the amount of data, which a single CD can hold. Progress has been made in data transfer speed by spinning the disc faster during read and by more densely packing data in a two-dimensional space. Packing data more densely has also resulted in increased data storage capacity.

In typical CD manufacture, a substrate having a top surface provided with concentric or spiral pre-grooves (guide grooves) and pits and lands is prepared using methods that include subjecting a photoresist layer formed on a glass to light exposure (laser cutting), developing and etching the resist layer, depositing and plating Ni to obtain a stamper, and then duplicating an information pattern for an optical disc from the stamper to a transparent polycarbonate substrate by using a UV curable resin to prepare a replicated transparent substrate of an optical disc.

In many cases, four layers are present in the construction of a CD. A first layer is typically made from optical grade, polycarbonate resin. This layer is manufactured by well-known techniques that usually begins by injection or compression molding the resin into a disc. The surface of the disc is molded or stamped with extremely small and precisely located pits and lands. These pits and lands have a predetermined size and, as explained below, are ultimately the vehicles for storing information on the disc.

After stamping, an optically reflective layer is placed over the information pits and lands. The reflective layer is often made of aluminum or an aluminum alloy and is between 40 to 100 nanometers (nm) thick. The reflective layer is usually deposited by one of many well-known vapor deposition techniques such as sputtering or thermal evaporation.

Next, a solvent-based or an UV (ultraviolet) curing-type resin is applied over the reflective layer, which is usually followed by a label. The third layer protects the reflective layer from handling and the ambient environment. And the label identifies the particular information that is stored on the disc, and sometimes, may include artwork.

The information pits residing between the polycarbonate resin and the reflective layer usually take the form of a continuous spiral. The spiral typically begins at an inside radius and ends at an outside radius. The distance between any 2 spirals is called the “track pitch” and is usually about 1.6 microns for CDs. The length of one pit or land in the direction of the track is from about 0.9 to about 3.3 μm.

The disc is read by pointing a laser beam through the optical grade polycarbonate substrate and onto the reflective layer with sufficiently small resolution to focus on the information pits. The pits have a depth of about ¼ of the wavelength of the laser light, and the light generally has a wavelength in the range of about 780 to 820 nanometers. Destructive (dark) or constructive (bright) interference of the laser light is then produced as the laser travels along the spiral track, focusing on an alternating stream of pits and lands in its path.

This on and off change of light intensity from dark to bright or from bright to dark forms the basis of a digital data stream of 1's and 0's. When there is no light intensity change in a fixed time interval, the digital signal is “0”, and when there is light intensity change from either dark to bright or bright to dark, the digital signal is “1”. The continuous stream of ones and zeros that results is then electronically decoded and presented in a format that is meaningful to the user such as music or computer programming data.

As a result, it is important to have a reflective coating on the disc to reflect the laser light from the disc and onto a detector in order to read the presence of an intensity change. In general, the reflective layer is usually aluminum, copper, silver, or gold, all of which have a high optical reflectivity of more than 80 percent from 650 nm to 820 nm wavelength. Aluminum and aluminum alloys are commonly used because they have a comparatively lower cost, adequate corrosion resistance, and are easily placed onto the polycarbonate disc.

Occasionally and usually for cosmetic reason, a gold or copper based alloy is used to offer the consumer a “gold” colored disc. Although gold naturally offers a rich color and satisfies all the functional requirements of a reflective layer, it is comparatively much more expensive than aluminum. Therefore, a copper-based alloy that contains zinc or tin is sometimes used to produce the gold colored layer. But unfortunately, the exchange is not truly satisfactory because the copper alloy's corrosion resistance, in general, is considered worse than aluminum, which results in a disc that has a shorter life span than one with an aluminum reflective layer.

Another type of disc in the compact disc family that has become popular is the recordable compact disc or “CD-R”. This disc is similar to the CD described above with a few exceptions. The recordable compact disc begins with a continuous spiral groove instead of a continuous spiral of pits and has a layer of organic dye between the polycarbonate substrate and the reflective layer. The disc is recorded by periodically focusing a laser beam into the grooves as the laser travels along the spiral track. The laser heats the dye to a high temperature, which in turn places pits in the groove that coincide with an input data stream of ones and zeros by periodically deforming and decomposing the dye.

The key component of a CD-R disc is the organic dye, which can be made from solvent and one or more organic compounds from the cyanine, phthalocyanine or azo family. The disc is normally produced by spin coating the dye onto the disc and sputtering the reflective layer over the dye after the dye is sufficiently dry. However, such dyes often contain halogen ions or other chemicals that can corrode the reflective layer, therefore, many commonly used reflective layer materials, such as aluminum, often do not provide a CD-R disc with a desirable life span. For this reason, gold is often used to manufacture a recordable CD. But while gold satisfies all the functional requirements of CD-R discs, it is a very expensive solution.

Recently, other types of recordable optical disks have been developed. These optical disks use a phase-change or magneto-optic material as the recording medium. An optical laser is used to change the phase or magnetic state (microstructural change) of the recording layer by modulating a beam focused on the recording medium while the medium is rotated to produce microstructural changes in the recording layer. During playback, changes in the intensity of light from the optical beam reflected through the recording medium are sensed by a detector. These modulations in light intensity are due to variations in the microstructure of the recording medium produced during the recording process. Some phase-change and/or magneto-optic materials may be readily and repeatedly transformed from a first state to a second state and back again with substantially no degradation. These materials may be used as the recording media for a compact disc-rewritable disc, or commonly known as CD-RW.

To record and read information, phase change discs utilize the recording layer's ability to change from a first dark to a second light phase and back again. Recording on these materials produces a series of alternating dark and light spots according to digital input data introduced as modulations in the recording laser beam. These light and dark spots on the recording medium correspond to 0's and 1's in terms of digital data. The digitized data is read using a low laser power focused along the track of the disc to play back the recorded information. The laser power is low enough such that it does not further change the state of the recording media but is powerful enough such that the variations in reflectivity of the recording medium may be easily distinguished by a detector. The recording medium may be erased for re-recording by focusing a laser of intermediate power on the recording medium. This returns the recording medium layer to its original or erased state.

Still another type of disc in the optical disc family that has become popular is a prerecorded optical disc called the digital videodisc or “DVD.” This disc has two halves. Each half is made of polycarbonate resin that has been injection or compression molded with pit information and then sputter coated with a reflective layer, as described above. These two halves are then bonded or glued together with an UV curing resin or a hot melt adhesive to form the whole disc. The disc can then be played from both sides as contrasted from the compact disc or CD where information is usually obtained only from one side. The size of a DVD is about the same as a CD, but the information density is considerably higher. The track pitch is about 0.7 micron and the length of the pits and lands is from approximately 0.3 to 1.4 microns.

One variation of the DVD family of discs is the DVD-dual layer disc. This disc also has two information layers; however, both layers are played back from one side. In this arrangement, the reflective layer is usually the same as that described above, however, the second layer is only semi-reflective with a reflectivity in the range of approximately 18 to 30 percent at 650 nm wavelength. In addition to reflecting light, this second layer must also pass a substantial amount of light so that the laser beam can reach the reflective layer underneath and then reflect back through the semi-reflective layer to the signal detector.

More recently, a blue light emitting laser diode with wavelength of 400 nm has been made commercially available. This laser enables much denser digital videodisc data storage. While current DVD using 650 nm red laser can store 4.7 GB per side, the new blue laser provides 12 GB per side, enough storage space for about 6 hours of standard-resolution video and sound. With a multi-layer disc, there is enough capacity for a featured movie in the high-definition digital video format.

Another format for optical discs is referred to as a “Blu-ray” disc. The Blu-ray disc system is characterized by a playback laser operating at a wavelength of about 405 nm (blue light) and an objective lens with a numerical aperture (NA) of 0.85. The storage capacity of this device, used with one information layer, is estimated to be about 25 gigabytes for the prerecorded format. Such devices have track pitch values in the 0.32 μm range and channel bit length on the order of 0.05 μm.

Because the focal depth of an objective lens with a NA of 0.85 is typically less than one micron, the tolerance of the optical path length variation is drastically reduced relative to currently used systems. Thus, a cover layer about 100 microns thick (the distance is measured from the surface of the disc to the information layer) has been proposed. The variation of the thickness of this cover layer is extremely critical to the success of this system. For example, a 2 or 3 μm thickness variation in the cover layer will introduce very high spherical aberration in the playback signal, potentially degrading the signal to an unacceptable low level.

Another DVD format is referred to as the High Density Digital Versatile Disc” (HD DVD), which preserves some of the features of the DVD, for example, an HD DVD can include two 0.6 mm thick half-discs glued together to create a symmetrical structure. The HD DVD system uses a playback laser with a wavelength of 405 nm and an objective lens with a NA of about 0.65. The storage capacity of the prerecorded type of HD DVD disc with one information layer is about 15 gigabytes. Although manufacturing an HD DVD disc is less complicated and less challenging than manufacturing a Blu-ray disc, it has some potential drawbacks. The playback signal quality of an HD DVD disc is strongly dependant upon the flatness of the disc. In order to deal with the variation of disc flatness introduced in the mass production of HD DVD discs, a tilt servo mechanism in the player is most likely required. The need for this mechanism increases the cost of players designed to read HD DVD discs.

Further, CD-RW techniques have been adapted to the DVD field to produce a rewritable DVD (DVD-RW) and phase-change rewritable discs such as Blu-ray or HD DVD. Some difficulties in the production of a DVD-RW have arisen due to the higher information density requirements of the DVD format. For example, the reflectivity of the reflective layer must be increased relative to that of the standard DVD reflective layer to accommodate the reading, writing, and erasing requirements of the DVD-RW format. Also, the thermal conductivity of the reflective layer must also be increased to adequately dissipate the heat generated by both the higher laser power requirements to write and erase information and the microstructural changes occurring during the information transfer process.

As increasing amounts of information are being stored in smaller and smaller spaces, the temperatures that CDs and DVDs operate at is increasing, especially for recordable discs. Thus, the dimensional stability of a CD or DVD substrate under such conditions has become more and more critical. The loss of moisture at elevated temperatures from a substrate material and poor heat tolerance, in general, are two factors that can cause dimensional instability in CD and DVD substrates.

Thus, there is a need in the art for CD and DVD substrate materials with good heat tolerance and low moisture pick up properties, i.e., hydroscopic that can overcome the problems in the prior art.

### SUMMARY OF THE INVENTION

The present invention provides a multilayer structure that includes a substrate layer comprising a mixture containing one or more copolymers that include polymerized residues from one or more styrenic monomers and one or more C₁-C₃₂ linear, branched, or cyclic alkyl(meth)acrylate monomers and/or maleic-type monomers and one or more elastomeric materials; and a reflective film layer coated on a surface of the substrate layer.

The present invention also provides an optical storage medium containing the above-described multilayer structure.

A particular embodiment of the invention provides an optical storage medium that includes:
a substrate layer containing a compounded interpenetrating polymer network that includes from about 60 to about 99.9 weight percent of one or more copolymers containing polymerized residues from one or more styrenic monomers and one or more C₁-C₃₂ linear, branched, or cyclic alkyl(meth)acrylate monomers and/or maleic-type monomers, and from about 0.1 to about 40 weight percent of one or more elastomeric materials that include polymerized residues from one or more styrenic monomers and one or more diene monomers, where the refractive index of the copolymers and the refractive index of the elastomeric materials are within 0.01 refractive index units of each other; and
a reflective metal film layer sputtered on a surface of the substrate layer, where the metal film layer comprises aluminum,
such that the optical storage medium includes a storage methodology selected from a pattern of features in at least one surface of the substrate layer, an optically recordable dye layer adjacent to the reflective layer, and a layer comprising an optically re-recordable material.
Another particular embodiment of the invention provides an optical storage medium that includes
a substrate layer containing a material prepared by polymerizing a mixture that includes about 60 to about 99.9 weight percent of a monomer mixture containing at least 60 weight percent of one or more styrenic monomers and up to 40 weight percent of one or more C₁-C₃₂ linear, branched, or cyclic alkyl(meth)acrylate monomers and/or maleic-type monomers, and about 0.1 to about 40 weight percent of one or more elastomeric materials that include polymerized residues from one or more styrenic monomers and one or more diene monomers, where the refractive index of the copolymers from the monomer mixture and the refractive index of the elastomeric materials are within 0.01 refractive index units of each other; and
a reflective metal film layer sputtered on a surface of the substrate layer, wherein the metal film layer comprises aluminum.

### DESCRIPTION OF THE DRAWINGS

FIG. 1 is a schematic cross-sectional view of an example of a multilayer structure that can be used as an optical recording medium according to the present invention;

FIG. 2 shows a schematic cross-sectional view of an optical storage system according to an embodiment of the invention;

FIG. 3 shows a schematic cross-sectional view of an optical storage system according to an embodiment of the invention;

FIG. 4 shows a schematic cross-sectional view of an optical storage system according to an embodiment of the invention;

FIG. 5 shows a schematic cross-sectional view of an optical storage system according to an embodiment of the invention;

FIG. 6 shows a schematic cross-sectional view of an optical storage system according to an embodiment of the invention;

FIG. 7 shows a schematic cross-sectional view of an optical storage system according to an embodiment of the invention;

FIG. 8 shows a schematic cross-sectional view of an optical storage system according to an embodiment of the invention;

FIG. 9 shows a schematic cross-sectional view of an optical storage system according to an embodiment of the invention;

FIG. 10 shows a schematic cross-sectional view of an optical storage system according to an embodiment of the invention;

FIG. 11 shows a schematic cross-sectional view of an optical storage system according to an embodiment of the invention;

FIG. 12 shows a schematic cross-sectional view of an optical storage system according to an embodiment of the invention;

FIG. 13 shows a schematic cross-sectional view of an optical storage system according to an embodiment of the invention; and

FIG. 14 shows a schematic cross-sectional view of an optical storage system according to an embodiment of the invention.

### DETAILED DESCRIPTION OF THE INVENTION

Other than in the operating examples or where otherwise indicated, all numbers or expressions referring to quantities of ingredients, reaction conditions, etc. used in the specification and claims are to be understood as modified in all instances by the term “about”. Accordingly, unless indicated to the contrary, the numerical parameters set forth in the following specification and attached claims are approximations that can vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

As used herein, the term “polymer” is meant to encompass, without limitation, oligomers, homopolymers, copolymers and graft copolymers.

Unless otherwise specified, all molecular weight values are determined using gel permeation chromatography (GPC) using appropriate polystyrene standards. Unless otherwise indicated, the molecular weight values indicated herein are weight average molecular weights (Mw).

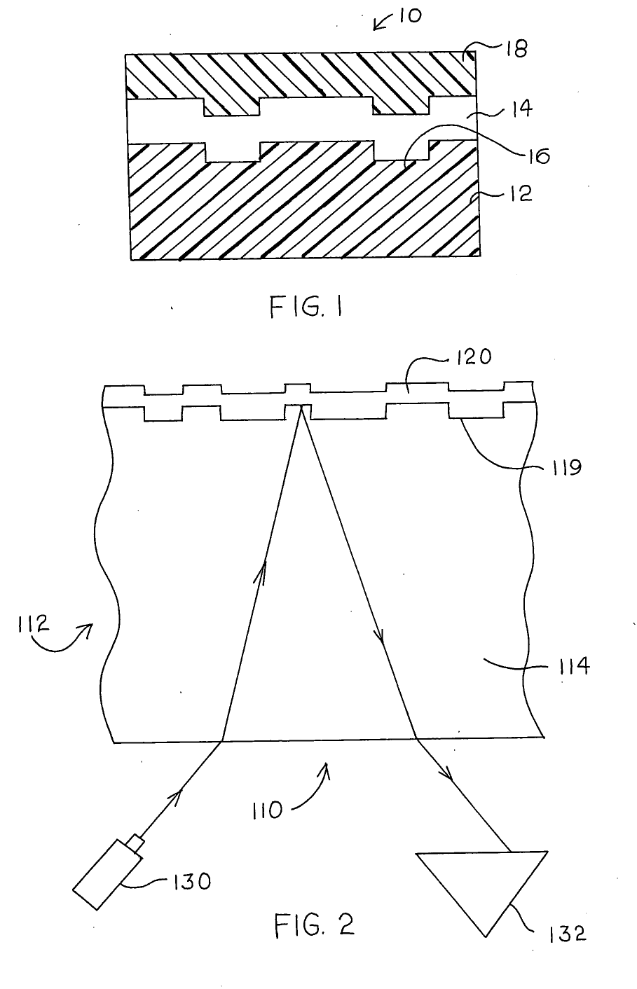

As shown in FIG. 1, multilayer structure 10, according to the present invention, includes a substrate layer 12 and a reflective film layer 14. Substrate layer 12, can include guide grooves 16. Overcoat layer 18 can optionally be applied over substrate layer 12 to protect it during handling.

In an embodiment of the invention (not shown), a solvent-based, or an UV (ultraviolet) curing-type resin, can be applied over the reflective layer, which can be followed by a label. This layer protects the reflective layer from handling and the ambient environment, and the label identifies the particular information that is stored on the disc, and can include artwork.

The substrate layer contains a mixture of copolymers that include polymerized styrenic and (meth)acrylate monomer and/or maleic-type monomers residues and one or more elastomeric materials.

Non-limiting examples of mixtures that can be used in the invention include those described in U.S. Pat. No. 7,193,014 and U.S. Patent Application Publication No. 2006/0100371 the relevant portions of which are incorporated herein by reference.

The mixture can include at least 60, in some cases at least 65, in other cases at least 70 weight percent copolymers and up to 99.9, in some cases up to 99, in other cases up to 95 and in some instances up to 90 weight percent copolymers based on the total weight of the mixture. Also, the mixture can include at least 0.1, in some cases at least 1, in other cases at least 5 and in some instances at least 10 weight percent elastomeric materials and up to 40, in some cases up to 35 and in other cases up to 30 weight percent elastomeric materials based on the total weight of the mixture. The exact amount of copolymers and elastomeric materials used in the mixture will vary depending on the particular physical properties desired in the substrate. The amount of copolymers and/or elastomeric materials in the mixture can be any value or range between any of the values recited above.

As used herein, the term “styrenic monomers” generally refers to arene compounds (non-limiting examples including benzene, toluene and naphthalene) containing a vinyl substituent group. As non-limiting examples, the styrenic monomers include those having 8 to 18 carbon atoms per molecule and in some cases those having 8 to 12 carbon atoms. Specific examples include, but are not limited to styrene, p-methyl styrene, α-methyl styrene, tertiary butyl styrene, dimethyl styrene, 3-methylstyrene, 2-ethylstyrene, 3-ethylstyrene, 4-ethylstyrene, 4-n-proplystyrene, 4-cyclohexylstyrene, 4-decylstyrene, 2-ethyl-4-benzylstyrene, 4-(4-phenyl-n-butyl)styrene, 1-vinylnaphthalene, 2-vinylnaphthalene, nuclear brominated or chlorinated derivatives thereof and combinations thereof.

In an embodiment of the invention, the styrenic monomers include styrene.

As non-limiting examples, the (meth)acrylate monomers include one or more C₁-C₃₂ linear, branched, or cyclic alkyl(meth)acrylate monomers. Specific examples include, but are not limited to methyl(meth)acrylate, ethyl(meth)acrylate, n-propyl(meth)acrylate, isopropyl(meth)acrylate, n-butyl(meth)acrylate, isobutyl(meth)acrylate, hexyl(meth)acrylate, decyl(meth)acrylate, dodecyl(meth)acrylate, octadecyl(meth)acrylate and combinations thereof.

In an embodiment of the invention, the (meth)acrylate monomers are selected from methyl(meth)acrylate, ethyl(meth)acrylate, n-butyl(meth)acrylate, isobutyl(meth)acrylate, and combinations thereof.

As used herein, the term “maleic-type monomers” refers to compounds having a carbon-carbon double bond situated between two carboxylic acid or carboxylic acid ester groups or in the form of a carboxylic acid anhydride. Suitable maleic-type monomers that can be used in the invention include, but are not limited to maleic anhydride, maleic acid, fumaric acid, C₁-C₁₂ linear, branched or cyclic alkyl esters of maleic acid, C₁-C₁₂ linear, branched or cyclic alkyl esters of fumaric acid, itaconic acid, C₁-C₁₂ linear, branched or cyclic alkyl esters of itaconic acid, itaconic anhydride and combinations thereof.

In embodiments of the invention, the copolymers are prepared by polymerizing a monomer mixture. The styrenic monomers can be present in the monomer mixture at a level of at least 25, in some cases at least 30, in other cases at least 35, in some instances at least 40, and in other instance at least 45 parts by weight, based on the weight of the monomer mixture. Also, the styrenic monomers can be present in the monomer mixture at a level of up to 90, in some cases up to 87.5, in other cases up to 85, in some instances up to 60, and in other instances up to 55 parts by weight based on the weight of the monomer mixture. The amount of styrenic monomers is determined based on the physical properties desired in the resulting substrate layer. The amount of styrenic monomers in the monomer mixture can be any value recited above or can range between any of the values recited above.

The (meth)acrylate monomers and/or maleic-type monomers can be present in the monomer mixture at a level of at least 10, in some cases at least 12.5 and in other cases at least 15 parts by weight based on the weight of the monomer mixture. Also, the (meth)acrylate monomers and/or maleic-type monomers can be present in the monomer mixture at a level of up to 70, in some cases up to 65, in other cases up to 60, in some instances up to 55, in other instances up to 50, in some situations up to 40, in other situations up to 30 and in some circumstances up to 25 parts by weight based on the weight of the monomer mixture. The amount and type of (meth)acrylate monomers and/or maleic-type monomers is determined based on the physical properties desired in the resulting substrate layer. The amount of (meth)acrylate monomers and/or maleic-type monomers in the monomer mixture can be any value recited above or can range between any of the values recited above.

In an embodiment of the invention, the monomer mixture can include one or more chain transfer agents. Any chain transfer agent that effectively controls the molecular weight of the copolymers can be used in the invention. Non-limiting examples of suitable chain transfer agents include alkyl mercaptans according to the structure R—SH, where R represents a C₁ to C₃₂ linear, branched or cyclic alkyl or alkenyl group; mercapto-acids according to the structure HS—R—COOX, where R is as defined above and X is H, a metal ion, N⁺H₄ or a cationic amine salt; dimers or cross-dimers of α-methylstyrene, methyl methacrylate, hydroxy ethylacrylate, benzyl methacrylate, allyl methacrylate, methacrylonitrile, glycidyl methacrylate, methacrylic acid, tert-butyl methacrylate, isocyanatoethyl methacrylate, meta-isopropenyl-α,α-dimethyl isocyanate, ω-sulfoxyalkyl methacrylates and alkali salts thereof. Suitable dimers that can be used in the invention are disclosed, for example, in U.S. Pat. No. 7,022,762, the relevant portions of which are herein incorporated herein by reference.

When used, the one or more chain transfer agents can be present in the monomer mixture at a level of from at least 0.001 wt. %, in some cases at least 0.01 wt. % and in other cases at least 0.1 wt. % and up to 10 wt. %, in some cases up to 7.5 wt. % and in other cases up to 5 wt. % of the monomer mixture. The amount of chain transfer agent can be any value or can range between any of the values recited above.

As used herein, the term “elastomeric material” refers to natural or synthetic rubber or rubberoid materials, which have the ability to undergo deformation under the influence of a force and regain its original shape once the force has been removed. Suitable elastomeric materials include, but are not limited to natural rubber, homopolymers of butadiene, homopolymers of isoprene, random block, AB diblock, ABA triblock, or multi-block copolymers of a conjugated diene with one or monomers selected from styrenic monomers, partially hydrogenated styrene, vinyl cyclohexane, (meth)acrylonitrile, C₁-C₃₂ linear, branched, or cyclic alkyl(meth)acrylate monomers (as described above) and combinations thereof.

In an embodiment of the invention, the elastomeric materials include a polymer containing styrenic monomer units and conjugated diene units. The polymer contains one or more blocks, where each block includes styrenic monomer units or conjugated diene units. If a block contains only one type of monomer unit, it can be termed a “monoblock”. If it contains both types of monomer units, it can be a random block, a tapered block, a stepwise block, or any other type of block.

In an embodiment of the invention, the elastomeric materials include one or more block copolymers selected from diblock and triblock copolymers of styrene-butadiene, styrene-butadiene-styrene, styrene-isoprene, styrene-isoprene-styrene, partially hydrogenated styrene-isoprene-styrene. Examples of suitable block copolymers include, but are not limited to, the STEREON® block copolymers available from the Firestone Tire and Rubber Company, Akron, Ohio; the ASAPRENE™ block copolymers available from Asahi Kasei Chemicals Corporation, Tokyo, Japan; the KRATON® block copolymers available from Kraton Polymers, Houston, Tex.; and the VECTOR® block copolymers available from Dexco Polymers LP, Houston, Tex.

In a particular embodiment of the invention, the styrenic monomer-conjugated diene copolymer is a random copolymer or a block copolymer containing styrene blocks and butadiene blocks. Copolymers of styrene and butadiene are typically clear resins known in the art as SBC resins and provide both high clarity and good stiffness properties. Non-limiting examples of SBC resins include the styrene-butadiene copolymers available under the K-Resin® trademark (Chevron Phillips Chemical Co., The Woodlands, Tex.).

The basic starting materials and polymerization conditions for preparing SBC resins are disclosed, as non-limiting examples, in U.S. Pat. Nos. 4,091,053; 4,584,346; 4,704,434; 4,704,435; 5,130,377; 5,227,419; 6,265,484; 6,265,485; 6,420,486; and 6,444,755, the relevant portions of which are herein incorporated by reference.

As used herein, the term “random” refers to copolymers or blocks within a block copolymer where, as a non-limiting example, the mole fractions of conjugated diene units and styrenic monomer units in one part of a polymer chain are substantially the same as the mole fractions of conjugated diene units and styrenic monomer units in the entire polymer chain.

A block is “tapered” when both (a) the mole fraction of conjugated diene units in a first section of the block is higher than the mole fraction of conjugated diene units in a second section of the block, where the second section of the block is closer to a given end of the block and (b) condition (a) is true for substantially all sections of the block. (Depending on the size of the sections being considered, condition (a) may not be true for all sections, but, if so, will not be true at more than about the level expected by chance).

A block is “stepwise” when a first section of the block contains substantially all monovinylarene units of the block, and a second section of the block contains substantially all conjugated diene units of the block. In light of the above definition, the first section is not necessarily prior to the second section in time, space, or any other parameter.

The SBC resin can contain at least 10, in some cases at least 15, in other cases at least 20 and in some instances at least 25 weight percent butadiene and/or other conjugated diene units. Also, the SBC resin can contain up to 80, in some cases up to 75, in other cases up to 70 and in some instances up to 65 weight percent butadiene and/or other conjugated diene units. The amount of butadiene and/or other conjugated diene units in the SBC resin can be any value or range between any of the values recited above.

The SBC resin can also contain at least 20, in some cases at least 25, in other cases at least 30 and in some instances at least 35 weight percent styrenic monomer units. Also, the SBC resin can contain up to 90, in some cases up to 85, in other cases up to 80 and in some instances up to 75 weight percent styrenic monomer units. The amount of styrenic monomer units in the SBC resin can be any value or range between any of the values recited above. In some embodiments of the invention, the multi-block copolymers can be star copolymers, comb copolymers, branched copolymers or combinations thereof.

In many embodiments of the invention, the refractive index of the copolymers and the elastomeric materials are very close in order to provide a transparent or nearly transparent substrate. In these embodiments, the refractive index of the copolymers and the refractive index of the elastomeric materials are within 0.01, in some cases within 0.005, in other cases within 0.001, and in some instance within 0.0001 refractive index units of each other, depending on the transparency required in the substrate.

In an embodiment of the invention, the mixture is prepared by physically blending and/or compounding the copolymers and the elastomeric materials. In this embodiment, the blends can be prepared by any suitable means including blending, tumbling and extrusion. Examples of these methods include, but are not limited to, dry mixing in the form of a powder, wet mixing in the form of a solution or slurry, and melt extrusion compounding.

Thus, the copolymers, elastomeric materials, and any other ingredients or additives, can be mechanically blended together in the desired proportions with the aid of any suitable mixing device conveniently used for mixing rubbers or plastics, as a non-limiting example by using a differential roll mill, a Banbury mixer, or an extruder.

In these embodiments, the copolymers, elastomeric materials, and any other ingredients or additives, can be in any form, such as, for example, fluff, powder, granulate, pellet, solution, slurry, and/or emulsion. Any additive can be combined with the copolymers, elastomeric materials, according to any method known in the art. Non-limiting examples of incorporation methods include, but are not limited to, dry mixing in the form of a powder and wet mixing in the form of a solution or slurry.

Melt extrusion compounding can be carried out using any suitable method such as in single screw or twin screw extruders or other melt extruders at temperatures above the melting and/or softening point of the copolymers and elastomeric materials.

In an embodiment of the invention, the copolymers and elastomeric materials in powder or granular form are blended, then extruded, and chopped into pellets and then molded to form the substrate.

In order to facilitate thorough mixing of the copolymers, elastomeric materials and to develop the desired combination of physical properties, the mechanical blending is carried out at a sufficiently high temperature to soften the copolymers, elastomeric materials, so that they are thoroughly dispersed and intermingled with each other. Mixing is continued until an essentially uniform blend is obtained.

In a particular embodiment of the invention, the blended mixture is a compounded interpenetrating polymer network of the copolymers and the elastomeric materials.

In another embodiment of the invention, the mixture is prepared by polymerizing a monomer mixture that includes one or more styrenic monomers and one or more C₁-C₃₂ linear, branched, or cyclic alkyl(meth)acrylate monomers in the presence of one or more elastomeric materials.

In this embodiment, the mixture is formed by dispersing the elastomeric material in a monomer mixture containing the styrenic monomers and alkyl(meth)acrylate monomers, deaerating or sparging with nitrogen, while mixing and adding a suitable free radical polymerization initiator at a suitable temperature to effect free radical polymerization. In a particular embodiment of the invention, at least some of the monomer mixture reacts with unsaturated groups in the elastomeric materials to provide grafting to the elastomeric materials. Methods for polymerizing the monomer mixture and elastomeric materials are known in the art. Examples of such methods are disclosed in, as non-limiting examples, U.S. Pat. Nos. 4,772,667 and 5,891,962, the relevant portions of which are herein incorporated by reference.

Any suitable polymerization initiator can be used in the invention. Non-limiting examples of suitable polymerization initiators include dibenzoyl peroxide, di-tert-butyl peroxide, dilauryl peroxide, dicumyl peroxide, didecanoyl peroxide, tert-butyl peroxy-2-ethylhexanoate, tert-butyl perpivalate, tert-butyl peroxyacetate, or butyl peroxybenzoate and also azo compounds, e.g., 2,2′-azobis(2,4-dimethylvaleronitrile), 2,2-azobis-(isobutyronitrile), 2,2′-azobis-(2,3-dimethylbutyronitrile), 1,1′-azobis-(1-cyclohexanenitrile), as well as combinations of any of the above.

When the mixture is prepared by polymerizing the monomer mixture in the presence of elastomeric materials, the styrenic and (meth)acrylate monomers and polymers formed therefrom make up a continuous phase and the elastomeric materials make up a dispersed phase. In embodiments of the invention, the dispersed phase is present as discrete particles dispersed within the continuous phase. Further to these embodiments, the volume average particle size of the dispersed phase in the continuous phase is at least about 0.1 μm, in some cases at least 0.25 μm and in other cases at least 0.5 μm. Also, the volume average particle size of the dispersed phase in the continuous phase can be up to about 11 μm, in some cases up to 10 μm, in other cases up to 5 μm, and in some instances up to 1 μm. The particle size of the dispersed phase in the continuous phase can be any value recited above and can range between any of the values recited above.

In some embodiments of the invention, the aspect ratio of the discrete particles is from at least about 1, in some cases at least about 1.5 and in other cases at least about 2 and can be up to about 5, in some cases up to about 4 and in other cases at least up to about 3. When the aspect ratio of the dispersed particles is too large, the resulting substrate layer is hazy and not clear or transparent. The aspect ratio of the dispersed discrete particles can be any value or range between any of the values recited above. As a non-limiting example, the aspect ratio can be measured by scanning electron microscopy or light scattering.

The particle size and aspect ratio of the dispersed phase can be determined using low angle light scattering. As a non-limiting example, a Model LA-910 Laser Diffraction Particle Size Analyzer available from Horiba Ltd., Kyoto, Japan can be used. As a non-limiting example, a rubber-modified polystyrene sample can be dispersed in methyl ethyl ketone. The suspended rubber particles can then be placed in a glass cell and subjected to light scattering. The scattered light from the particles in the cell can be passed through a condenser lens and converted into electric signals by detectors located around the sample cell. As a non-limiting example, a He—Ne laser and/or a tungsten lamp can be used to supply light with a shorter wavelength. Particle size distribution can be calculated based on Mie scattering theory from the angular measurement of the scattered light.

In an embodiment of the invention, the additives include pigments or colorants or both. The pigments and/or colorants can be included in the mixture and are included as part of the resulting substrate layer. As non-limiting examples, the pigments and/or colorants can include titanium dioxide. The pigments and/or colorants when added to the mixture will generally result in an opaque substrate layer. A clear or transparent substrate layer can be defined as having Haze values of 10% or less, and it is known to those skilled in the art that Haze values generally do not apply to an opaque sheet.

As used herein, “pigments and/or colorants” refer to any suitable inorganic or organic pigment or organic dyestuff. Suitable pigments and/or colorants are those that do not adversely impact the desirable physical properties of the thermoplastic sheet. Non-limiting examples of inorganic pigments include titanium dioxide, iron oxide, zinc chromate, cadmium sulfides, chromium oxides and sodium aluminum silicate complexes. Non-limiting examples of organic type pigments include azo and diazo pigments, carbon black, phthalocyanines, quinacridone pigments, perylene pigments, isoindolinone, anthraquinones, thioindigo and solvent dyes.

In another embodiment of the invention, the additives can include one or more additives selected from lubricants, fillers, light stabilizers, heat stabilizers, surface-active agents, and combinations thereof. These additives, when added to the mixture can result in an opaque substrate layer.

Suitable fillers are those that do not adversely impact, and in some cases enhance, the desirable physical properties of the substrate layer. Suitable fillers include, but are not limited to, calcium carbonate in ground and precipitated form, barium sulfate, talc, glass, clays such as kaolin and montmorolites, mica, and combinations thereof.

Suitable lubricants include, but are not limited to, ester waxes such as the glycerol types, the polymeric complex esters, the oxidized polyethylene type ester waxes and the like, metallic stearates such as barium, calcium, magnesium, zinc and aluminum stearate, and/or combinations thereof.

Generally, any conventional ultra-violet light (UV) stabilizer known in the art can be utilized in the present invention. Non-limiting examples of suitable UV stabilizers include 2-hydroxy-4-(octyloxy)-benzophenone, 2-hydroxy-4-(octyloxy)-phenyl phenyl-methanone, 2-(2′-hydroxy-3,5′di-teramylphenyl)benzotriazole, and the family of UV stabilizers available under the trade TINUVIN® from Ciba Specialty Chemicals Co., Tarrytown, N.Y.

Heat stabilizers that can be used in the invention include, but are not limited to, hindered phenols, non-limiting examples being the IRGANOX® stabilizers and antioxidants available from Ciba Specialty Chemicals.

When any or all of the indicated additives are used in the present invention, they can be used at a level of at least 0.01 weight percent, in some cases at least 0.1 weight percent and in other cases at least 0.5 and up to 10 weight percent, in some cases up to 7.5 weight percent, in other cases up to 5 weight percent, and in some situations up to 2.5 weight percent of the mixture and/or the substrate layer of the invention. The amount, type and combination of adjuvants used will depend on the particular properties desired in the substrate layer. The amount of any single adjuvant or any combination of adjuvants can be any value recited above and can range between any of the values recited above.

Thorough mixing and dispersion of the additives in the mixture is important, but otherwise processing conditions are similar to those typically employed in the art.

In other embodiments of the invention, the substrate layer can include a blend of the mixture of copolymers and elastomeric materials and other suitable polymers. Suitable other polymers include those that provide the substrate layer with the desirable properties described herein. Suitable other polymers include, but are not limited to polycarbonates, poly(meth)acrylates, polyamides, polyesters and combinations thereof.

When the blend described above is used, the blend can include mixture of copolymers and elastomeric materials at a level of at least 50, in some cases at least 55, in other cases at least 60, in some instances at least 65 and in other instances at least 70 weight percent based on the total weight of the blend. Also, the blend can contain up to 99, in some cases up to 95 and in other cases up to 90 weight percent of the mixture of copolymers and elastomeric materials based on the total weight of the blend. The amount of the mixture of copolymers and elastomeric materials in the blend can be any value or range between any of the values recited above.

Further, when the blend described above is used, the blend can include the other polymers at a level of at least 1, in some cases at least 5 and in other cases at least 10 weight percent based on the total weight of the blend. Also, the blend can contain up to 50, in some cases up to 45, in other cases up to 40, in some instances up to 35, and in other instances up to 30 weight percent of the other polymers based on the total weight of the blend. The amount of the other polymers in the blend can be any value or range between any of the values recited above.

In embodiments of the invention, the substrate layer adsorbs and/or absorbs moisture after molding at a rate less than that observed for substrates made from polycarbonate resins. Due to this low “moisture pick up” property of the present substrate layer, the multi-layer structures, according to the invention, have improved dimensional stability compared to those currently used. In addition to the lower cost of the present substrate layer, because of the lower processing temperatures and melt flow at lower pressures that can be used in making the present substrate layer, processing is easier and less expensive with the added benefit of being able to mold in finer features.

The present multilayer structure also includes a reflective film layer coated on a surface of the substrate layer. In many embodiments of the invention, the reflective film layer includes a metal film.

Metal alloys that can be used in the metal film include those disclosed in U.S. Pat. Nos. 6,905,750 B2, 6,007,889, 6,280,811, 6,451,402 B1 and 6,544,616 B2, the relevant portions of which are herein incorporated by reference.

In embodiments of the invention, the metal film includes one or more elements selected from Al, Se, Ti, V, Mn, Fe, Co, Ni, Cr, Cu, Zn, Ga, Sn, Pd, Pt, Au, Ag, In, Sb, Te, W, Ta, Mg, O, B, N, C, P, Si and compounds containing combinations thereof.

In particular embodiments of the invention, the metal film includes one or more elements selected from Al, Au, As, In, Sb, Te, Cr, Ge, Sb, Tb, Fe, Co Bi and compounds containing combinations thereof.

In another particular embodiment of the invention, the metal film includes a metal alloy containing silver, copper, and an element A, where element A is selected from cadmium, lithium, indium, chromium, antimony, gallium, germanium, boron, molybdenum, zirconium, and beryllium.

In other particular embodiments of the invention, the metal film includes aluminum.

In some embodiments of the invention, the metal film includes silver and/or silver compounds and/or alloys.

As used herein, the term “adjacent” refers to a spatial relationship and means “nearby” or “not distant”. Accordingly, the term “adjacent”, as used in this specification does not require that items so identified are in contact with one another and that they may be separated by other structures.

Embodiments of the invention provide an optical storage medium with a substrate layer having a pattern of features in at least one major surface and a reflective layer adjacent to the feature pattern. The reflective layer can be made of a silver and zinc alloy.

Another embodiment of the invention provides an optical storage medium with a substrate layer having a pattern of features in at least one major surface and a reflective layer adjacent the feature pattern. The reflective layer can be made of a silver and aluminum alloy.

An additional embodiment of the invention provides an optical storage medium with a substrate layer having a pattern of features in at least one major surface and a reflective layer adjacent to the feature pattern. The reflective layer can be made of a silver and zinc and aluminum alloy.

Further embodiments of the invention provide an optical storage medium with a substrate layer having a pattern of features in at least one major surface and a reflective layer adjacent to the feature pattern. The reflective layer can be made of a silver and manganese alloy.

Some embodiments of the invention provide an optical storage medium with a substrate layer having a pattern of features in at least one major surface and a reflective layer adjacent the feature pattern. The reflective layer can be made of a silver and germanium alloy.

Other embodiments of the invention provide an optical storage medium with a substrate layer having a pattern of features in at least one major surface and a reflective layer adjacent the feature pattern. The reflective layer is made of a silver and copper and manganese alloy.

In the embodiments that follow, and referring to the various figures, all references to “substrate layers” should be construed as referring to the substrate layer described herein and references to “reflective film layers” refer to and include the various embodiments of reflective film layers described herein.

The invention provides multilayer structures that can be used as optical data storage media. One embodiment of the invention is shown in FIG. 2 as optical data storage system 110. Optical storage medium 112 includes substrate layer 114, and a reflective film layer 120 on a first data pit pattern 119. An optical laser 130 emits an optical beam toward medium 112, as shown in FIG. 2. Light from the optical beam that is reflected by reflective film layer 120 is sensed by detector 132, which senses modulations in light intensity based on the presence or absence of a pit or land in a particular spot on the thin film layer. In an alternative embodiment (not shown), the disc can be varied by attaching two optical storage media 112 back-to-back, that is, with each transparent substrate 114 facing outward. The attachment method could be by UV cured adhesive, hot melt adhesive or other type of adhesives.

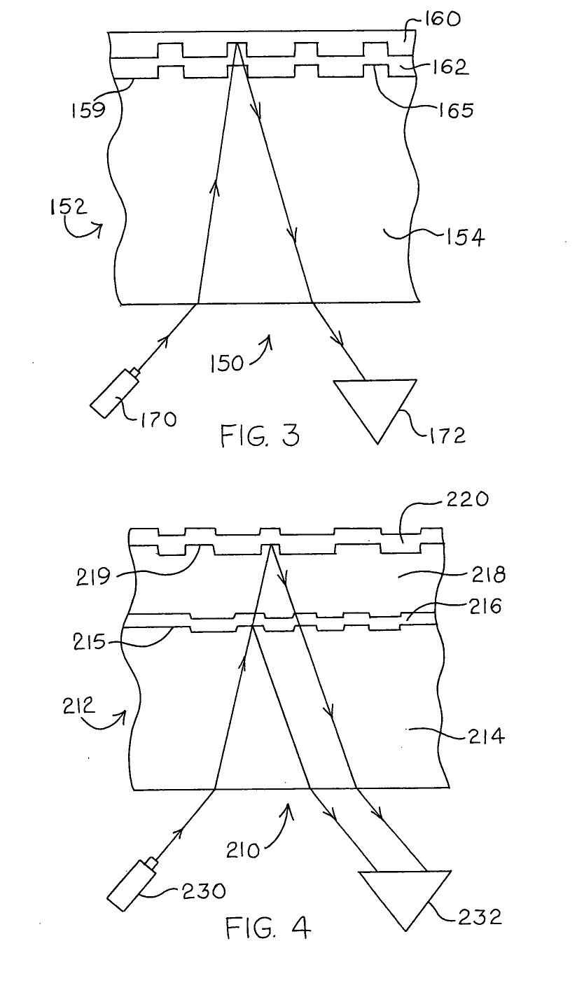

Another embodiment of the invention is shown in FIG. 3 as optical data storage system 150. Optical storage medium 152 includes a substrate 154, and a reflective film layer 160, over a layer of dye 162, placed over a spiral pattern of ridges 159 and grooves 165. An optical laser 130 emits an optical beam toward medium 152, as shown in FIG. 3. As discussed above, data is placed on the disc by deforming portions of the dye layer with a laser. The spiral ridge and groove structure can aid in separating deformation spots and preventing overlapping of deformation spots. Thereafter, the disc is played by light from the optical beam, which is reflected by reflective film layer 160 and sensed by detector 172. Detector 172 senses modulations in light intensity based on the presence or absence of a deformation in the dye layer. In an alternative embodiment (not shown), the disc can be varied by attaching two optical storage media 152 back-to-back, that is, with each transparent substrate 154 facing outward. The attachment method could be by UV cured adhesive, hot melt adhesive or other type of adhesives.

Another embodiment of the invention is shown in FIG. 4 as optical data storage system 210. Optical storage medium 212 includes a substrate layer 214, a partially reflective film layer 216 on a first data pit pattern 215, a transparent spacer layer 218, and a reflective film layer 220 on a second data pit pattern 219. An optical laser 230 emits an optical beam toward medium 212, as shown in FIG. 4. Light from the optical beam that is reflected by either reflective film layer 216 or 220 is sensed by detector 232, which senses modulations in light intensity based on the presence or absence of a pit in a particular spot on the thin film layers. In an alternative embodiment (not shown), the disc can be varied by attaching two optical storage media 212 back-to-back, that is, with each transparent substrate 214 facing outward. The attachment method could be by UV cured adhesive, hot melt adhesive or other type of adhesives.

The transparent spacer layers as described herein can be any suitable transparent polymer or resin. Non-limiting examples of materials that can be included in the spacer layer include polycarbonates, poly(meth)acrylates, polyamides, polyesters, the mixture for the substrate layer described herein, and combinations and/or blends thereof.

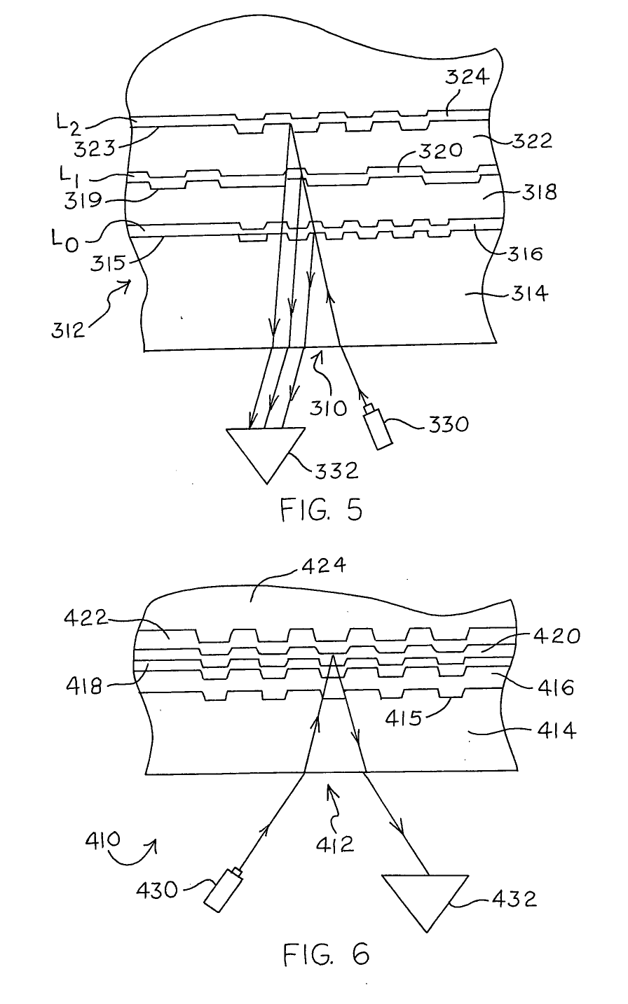

Another embodiment of the invention is shown in FIG. 5 as optical data storage system 310. Optical storage medium 312 includes a substrate 314, a partially reflective film layer 316 or L₀ on a first data pit pattern 315, a transparent spacer layer 318, another partially reflective film layer 320 or L₁ on a second data pit pattern 319, a second transparent spacer layer 322, and a reflective film layer 324 or L₂ on a third pit pattern 323. An optical laser 330 emits an optical beam toward medium 312, as shown in FIG. 5. Light from the optical beam that is reflected by thin film layer 316, 320 or 324 is detected by detector 332, which senses modulation in light intensity based on the presence or absence of a pit in a particular spot on the reflective film layers. To playback the information on L₂, the light beam from laser diode 330 goes through the transparent substrate, passing through the first semi-reflective L₀, and the second semi-reflective L₁ and then reflected back from L₂ to the detector 332. In another alternative (not shown), the disc may be varied by attaching two optical storage media 312 back-to-back, that is, with each transparent substrate 314 facing outward. The attachment method could be by UV cured adhesive, hot melt adhesive or other type of adhesives.

As used herein, the term “semi-reflective layer” refers to a layer having a reflectivity in the range of about 10 to 75, in some cases about 15 to 60, in some instances about 18 to 50, and in other instances about 18 to 30 percent at the wavelength of the light in the laser beam that is employed. In addition to reflecting light, this second layer must also pass a substantial amount of light so that the laser beam can reach the reflective layer underneath and then reflect back through the semi-reflective layer to the signal detector. The amount of light that passes through will vary based on the desired properties of the particular optical storage medium.

Still another embodiment of the invention is shown in FIG. 6 as optical data storage system 410. Optical storage medium 412 includes a substrate layer 414, a dielectric layer 416 on a first data pit pattern 415, a recording layer 418 made of a material having a microstructure including domains or portions capable of repeatedly undergoing laser-induced transitions from a first state to a second state and back again (i.e., an optically re-recordable or rewritable layer), such as a phase change material or a magneto-optic material, another dielectric material 420, a reflective film layer 422, and a substrate layer 424. The different layers 414, 416, 418, 420 and 422 of the optical storage medium 410 can be oriented so as to be adjacent with one another.

As used herein, “dielectric material” refers to a material that is an electrical insulator or in which an electric field can be sustained with a minimum dissipation of power. Also, “dielectric layer” refers to a portion of a multilayer structure that includes a dielectric material.

As used herein, the term “phase change material” refers to materials that can exist in crystalline or amorphous solid state phases and are capable of changing from one phase to the other when heated and cooled. In embodiments of the invention, suitable phase change materials are those where the two solid states reflect light differently. As a non-limiting example, materials where the amorphous state reflects less light than the crystalline state so when the material is heated using laser light, small spots are changed to the amorphous state, which appear as dark spots. In other words, heating the material with the laser beam above its melting point transforms it from crystalline to amorphous. The rapid cooling of the spot causes the material to freeze in the amorphous state. These spots can then be erased in a process known as annealing. This is accomplished by heating the material and then cooling to a lower temperature, which transforms it back to its crystalline state. Existing data can be overwritten by turning the laser on continuously to the erase power, which will erase any existing marks. Switching the laser to a higher power, one sufficient to melt the material, enables the creation of a new mark. Examples of suitable phase change materials are disclosed in U.S. Pat. No. 5,974,025, the relevant potions of which are incorporated herein by reference.

As used herein, the term “magneto optical material” refers to materials that demonstrate the magneto optical effect, which arises when light interacts with a medium in the presence of a magnetic field. Non-limiting examples of magneto optical effects include the rotation of light's polarization plane or changes in light scattering characteristics as it propagates through a medium placed in a longitudinal or transverse magnetic field.

In embodiments of the invention, the phase change materials for recording layer 418 include germanium-antimony-tellurium (Ge—Sb—Te), silver-indium-antimony-tellurium (Ag—In—Sb—Te), chromium-germanium-antimony-tellurium (Cr—Ge—Sb—Te) and the like. Also, the used materials for dielectric layer 416 or 420 can include zinc sulfide-silica compound (ZnS.SiO₂), silicon nitride (SiN), aluminum nitride (AlN) and the like. Additionally, the magneto optical materials for recording layer 418 can include terbium-iron-cobalt (Tb—Fe—Co) or gadolinium-terbium-iron (Gd—Tb—Fe).

In embodiments of the invention, the recording layer can be an organic material as described in U.S. Pat. No. 6,936,325, the relevant portions of which are herein incorporated by reference.

As shown in FIG. 6, optical laser 430 emits an optical beam toward medium 412. In the recording mode for the phase change recordable optical medium, light from the optical beam is modulated or turned on and off according to the input digital data and focused on recording layer 418 with suitable objective while the medium is rotated at a suitable speed to effect microstructural or phase change in recording layer 418. In the playback mode, the light from the optical beam that is reflected by the reflective film layer 422 through medium 412 is sensed by detector 432, which senses modulations in light intensity based on the crystalline or amorphous state of a particular spot in the recording layers. In another alternative (not shown), the disc can be varied by attaching two optical storage media 412 back-to-back, that is, with each transparent substrate 414 facing outward. The attachment method could be by UV cured adhesive, hot melt adhesive or other type of adhesives.

In an embodiment of the invention shown in FIG. 6, substrate layer 414 is about 1.2 mm thick with continuous spirals of grooves and lands, layer 424 is a UV cured acrylic resin 3 to 15 microns thick acting as a protective layer with the playback laser 430 at 780 to 820 nanometer, and rewritable layer 418 is a phase change material of a typical composition such as Ag—In—Sb—Te. It is a compact disc-rewritable disc structure, commonly known as a CD-RW. To record and read information, phase change discs utilize the recording layer's ability to change from an amorphous phase with low reflectivity (dark) to a crystalline phase with high reflectivity (bright). Before recording, the phase change layer is in a crystalline state. During recording, a laser beam with high power focused on the recording layer will heat the phase change material to high temperature and when the laser is turned off, the heated spot will cool off very quickly to create an amorphous state. Thus a series of dark spots of amorphous states are created according to the input data of turning the focused laser beam on and off. These on and off's correspond to “0” and “1” of a digital data stream.

In reading, a low laser power is used to focus on and read the dark or bright spots along the track of the disc to play back the recorded information. To erase, an intermediate laser power is used to focus on the grooves or tracks with the disc spinning so that an intermediate temperature of the focused spots is reached. After the laser is moved to another location, the spots cool to room temperature forming a crystalline structure of high reflectivity. This returns the recording layer to its original or erased state. The change of the spots' state from amorphous to crystalline is very reversible, thus many record and erase cycles can be accomplished and different data can be repeatedly recorded and read back without difficulty.

In embodiments of the invention, substrate layer 414 is about 0.5 to 0.6 mm thick with continuous spirals of grooves and lands, layers 416 and 420 are dielectric layers typically made of ZnS.SiO₂, layer 418 is made of a phase change material such as Ag—In—Sb—Te, Ge—Sb—Te, or other materials as indicated below, layer 422 can include a silver alloy, and layer 424 is a UV cured resin bonding another half of the same structure as depicted in FIG. 6, and the structure is used with a read and write laser 430 at 630 to 650 nanometer wavelength. Then it is a digital versatile disc with rewritable capability, commonly referred to as DVD+RW. Non-limiting examples of phase-changeable materials that can be used include materials from the following series: As—Te—Ge, As—In—Sb—Te, Te—Ge—Sn, Te—Ge—Sn—O, Bi—Ge, Bi—Ge—Sb, Bi—Ge—Te, Te—Se, Sn—Te—Se, Te—Ge—Sn—Au, Ge—Sb—Te, Sb—Te—Se, In—Se—Tl, In—Sb, In—Sb—Se, In—Se—Tl—Co, Cr—Ge—Sb—Te and Si—Te—Sn, where As is arsenic, Bi is Bismuth, Te is tellurium, Ge is germanium, Sn is tin, O is oxygen, Se is selenium, Au is gold, Sb is antimony, In is indium, Tl is thallium, Co is cobalt, and Cr is chromium.

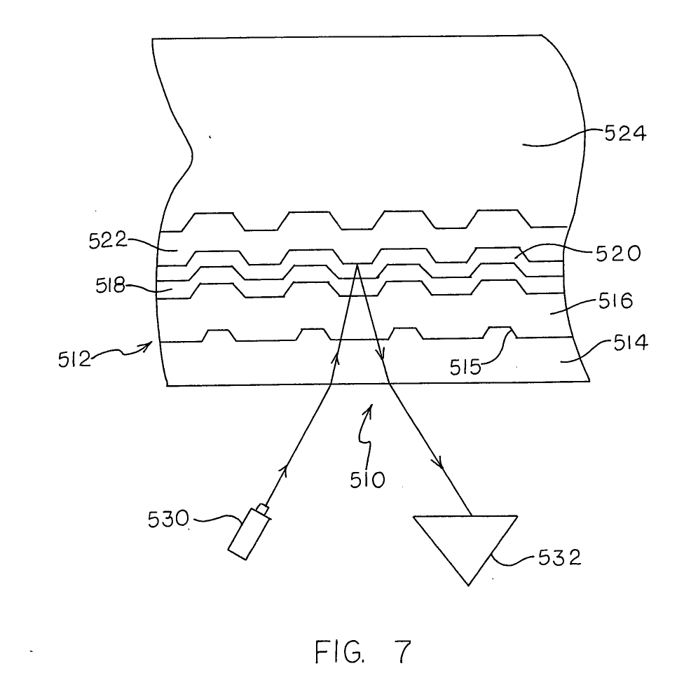

Another embodiment of the invention is shown in FIG. 7, which shows a rewritable type optical information storage system 510. Transparent cover layer 514 is approximately 0.1 mm thick. Dielectric layers 516 and 520 can be made of ZnS.SiO₂ and serve as a protective layer for the rewritable layer or phase change layer 518. Rewritable layer 518 can be formed from Ag—In—Sb—Te or the like. Reflective layer 522 can be formed from a silver alloy. Substrate layer 524 can be about 1.1 mm in thickness with continuous spiral tracks of grooves and lands. Laser 530 can have a wavelength of about 400 nm with associated optics to focus the laser beam onto recording layer 518. The reflected laser beam is received by the detector 532, which can include associated data processing capability to read back the recorded information. System 510 is sometimes referred to as a “Digital Video Recording System” or DVR, and it is designed to record high definition television signals. The principle of operation of optical information storage system 510 is similar to that of a CD-RW disc, except that the recording density is considerably higher, the storage capacity of a 5 inch diameter disc is approximately 20 gigabytes. Again the performance of the disc stack depends on a layer 522, that is reflective at 400 nm wavelength.

Other optical recording media which can be used to practice this invention include, for example, optical storage devices readable, and, in some embodiments, also rewritable from both sides of the device.

Additional embodiments of the invention are shown in FIG. 8 as optical data storage system 610. Optical storage system 610 is sometimes referred to as DVD-14 and is illustrative of devices that have the capacity to store accessible data on both sides of the structure.

Optical storage system 610 includes a 0.6 mm thick substrate layer (S), adjacent to the S layer or a part of the S layer is a first data pit pattern 614 that includes a series of pits and lands. Adjacent to layer 614 and conforming to the contour of layer 614 is a semi-reflective layer 618. Adjacent to layer 618 is a spacer layer 622 adjacent to or a part of spacer layer 622 is a second data pit pattern 626 that includes a series of pits and lands. Adjacent to and conforming to the contour of second data pit pattern 626 is a reflective layer 630. Both semi-reflective layer 618 and reflective layers 630 can be read from the same side of structure 610.

Adjacent to layer 634 is a second reflective layer 638. Layer 638 is adjacent to and conforms to the contours of a third data pit pattern 642 that includes a series of pits and lands. Third data pit pattern 642 and reflective layer 638 are readable from the side of the device opposite to the side of the device from which data pit patterns 618 and 626 are read. Adjacent to or including data pit pattern 642 is a second 0.6 mm thick substrate layer (S).

An optical laser 660 emits an optical beam towards second substrate layer S, the beam is reflected by reflective layer 638 and sensed by detector 662 as modulations in light intensity based on the presence or absence of a pit in a particular spot on the reflective layer.

As illustrated in FIG. 8, from the side of device 610 opposite of laser 660, a second optical beam from laser 650 is directed towards first substrate layer S towards data pit pattern 614. As illustrated in FIG. 8, the second laser 650 emits an optical beam towards semi-reflective layer 618 and reflective layer 630. At least a portion of the optical beam emitted by laser 650 passes through semi-reflective layer 618 to reach reflective layer 626. Light from the optical beam that is reflected by layer 626 is sensed by detector 652, which senses modulations in light intensity based on the presence or absence of a pit or land in a particular spot on the reflective layer.

While the optical storage device illustrated in FIG. 8 includes multiple laser sources 650 and 660 and multiple detectors 652 and 662, the same could be accomplished using a single laser source and detector configured such that the same optical beam source and detector can be used to collect signal from all sets of information pits and lands including the device, for example, set 618, 626 and 642.

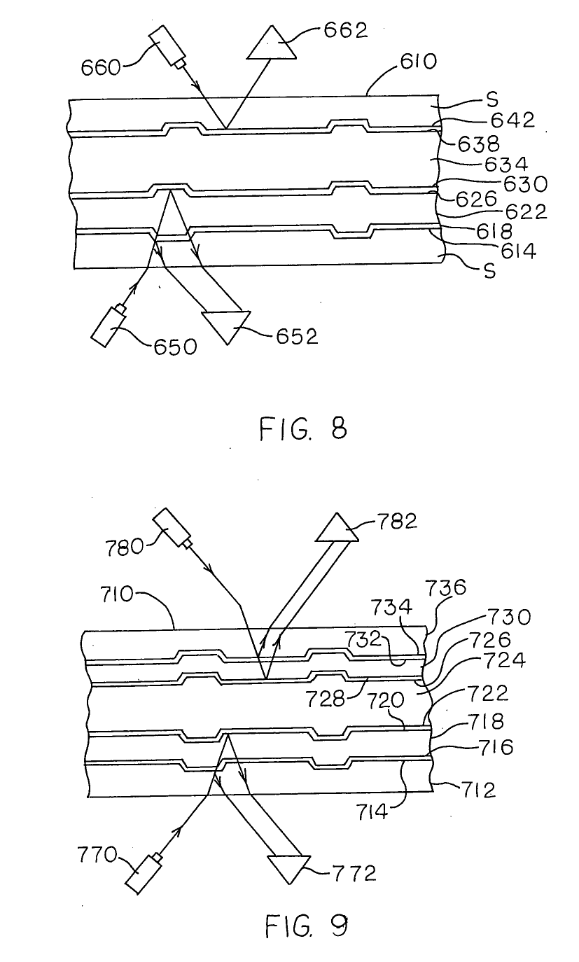

In still another embodiment, the invention can be practiced using the optical storage system 710 as illustrated in FIG. 9. Optical storage medium 710 is illustrative of a DVD-18 and is representative of optical storage systems that have multiple information layers readable from both sides of the optical storage medium.

Optical storage system 710 includes a 0.6 mm thick substrate layer 712 adjacent to, or comprising a first data pit pattern 714. Data pit pattern 714 includes a series of pits and lands and is adjacent to a semi-reflective layer 716. The device further includes a transparent spacer layer 718 about 50 microns thick, and a second data pit pattern 720 adjacent to a reflective film 722. Both semi-reflective layer 716 and reflective layer 722 can be read from the same side of 710.

An optical laser 770 emits an optical beam towards substrate layer 712. As illustrated in FIG. 9, at least a portion of the optical beam emitted by laser source 770 passes through semi-reflective layer 716 to reach reflective layer 722. Light from the optical beam that is reflected by semi-reflective layer 716 and reflective layer 722 is sensed by detector 772, which senses modulations in light intensity based on the presence or absence of a pit or land in a particular spot on the reflective layer or the semi-reflective layer.

The optical storage device illustrated in FIG. 9 further includes the spacer layer 724, which connects the portion of the device including the first two information layers 714 and 720 with the portion of the device including the third and forth information layers 728 and 734. Substrate layer 724 is adjacent to and separates reflective layer 728 and reflective layer 722.

Reflective layer 724 is adjacent to, and conforms to the contours of the pit and lands or data pit pattern layer 728. Layer 728 is adjacent to spacer layer 726, spacer layer 726 is adjacent to semi-reflective layer 732, which is adjacent to, and conforms to the contours of data pit pattern layer 734. Data pit pattern layer 734 is contiguous with, or adjacent to, 0.6 mm thick substrate layer 736.

In the embodiment illustrated in FIG. 9, an optional second optical laser 780 is provided which emits an optical beam towards layer 736. A portion of the light emitted by laser 780 passes through semi-reflective layer 732 and is reflected by reflective layer 724. Light reflected by semi-reflective layer 732 and reflective layer 724 is sensed by detector 782, which senses modulations in light intensity based on the presence or absence of a pit or land in a particular spot on the reflective layer.

While the optical storage device illustrated in FIG. 9 includes multiple laser sources 770 and 780 and multiple detectors 752 and 772, the same could be accomplished using a single laser source and detector configured such that the same optical beam source and detector can be used to collect signals from all sets of information pits and lands comprising the device.

Yet another embodiment of the inventions includes an optical storage device referred to as “Blu-ray”. Blu-ray devices incorporate lasers, which operate at a wavelength of 405 nm and lenses, with a numerical aperture of 0.85.

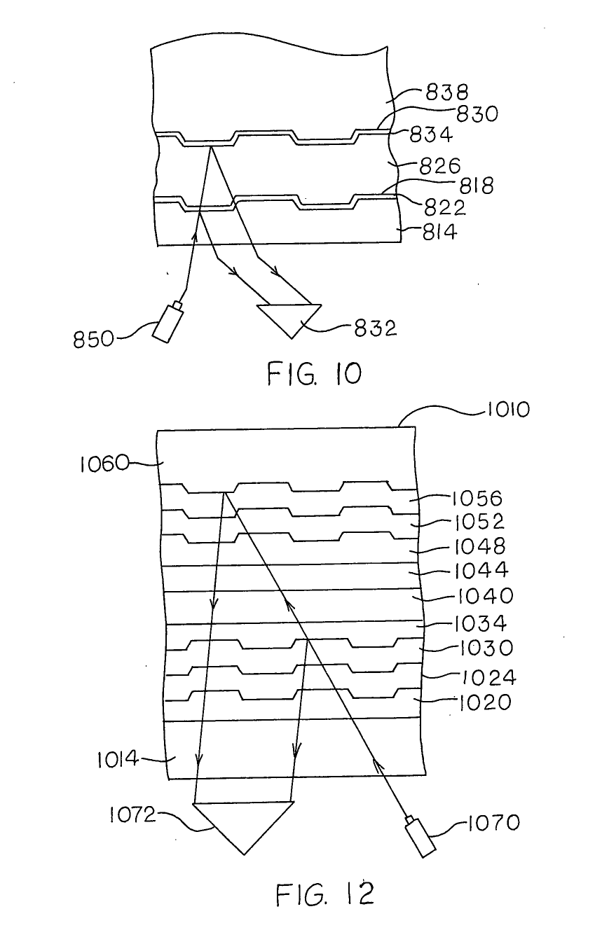

As illustrated in FIG. 10, optical storage system 810 of the prerecorded type of “Blu-Ray” disc includes two sets of information pits and lands 818 and 830 readable from the same side of the device. Device 810 includes transparent cover layer 814 about 0.1 mm in thickness, and a substrate layer 838 about 1.1 mm thickness with an adjacent reflective layer 834. Reflective layer 834 is adjacent to, and conforms to the second data pit pattern 830 injection molded onto the substrate 838. Data pit pattern 830 includes a set of pits and lands and is adjacent to, or a part of, substrate 838. Layer 826 is adjacent to the semi-reflective layer 822. Semi-reflective layer 822 is adjacent and conforms to first data pit pattern 818 including a set of pits and lands. Data pit 818 is adjacent to or a part of the transparent cover layer 814.

As illustrated in FIG. 10, an optical beam source laser 850 is provided, as is detector 852. Optical laser 850 emits an optical beam towards layer 814 through an objective lens (not shown in FIG. 10). A portion of the light emitted by laser 850 passes through a lens (not shown), the semi-reflective layer 822 and is reflected by reflective layer 834 and sensed by detector 852, which senses modulations in light intensity based on the presence or absence of a pit or land in a particular spot on the reflective layer 822.

A portion of the optical beam emitted by optical laser 850 is partially reflected by semi-reflective layer 822 and is sensed by detector 852, which senses modulations in light intensity based on the presence or absence of a pit or land in a particular spot on semi-reflective layer 822.

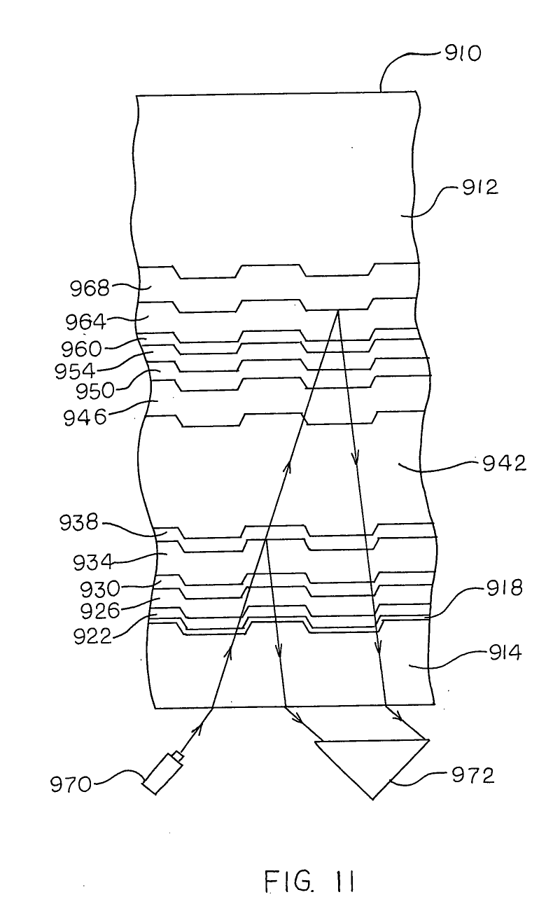

In one embodiment of the invention, as illustrated in FIG. 11, an optical storage device 910 of the Blu-ray rewritable type further includes two read and rewritable layers 926 and 954. Optical storage device 910 includes a substrate layer 972 about 1.1 mm thick; adjacent to reflective layer 968. Adjacent to reflective layer 968 is a first dielectric layer 964; adjacent to layer 964 is a first interface layer 960. Adjacent to layer 960 is a phase-change type recording layer 954 with thickness of about 10 to 15 nm; adjacent to layer 954 is layer 950 a second layer. Adjacent to layer 950 is layer 946 a second dielectric layer.

Optical storage device 910 further includes an intermediate layer 942 sandwiched between the dielectric layer 946 approximately 20 to 40 microns thick and a semi-reflective layer 938 about 10 nm thick. A third dielectric layer 934 is adjacent to reflective layer. Adjacent to layer 934 is a third Interface layer 930, a recording layer 926 6-10 nm thick containing a phase-change material is sandwiched between layers 930 and a forth interface layer 922. Adjacent to layer 922 is a forth layer of dielectric material layer 918. Adjacent to layer 918 is a transparent cover layer 914 about 80 to 100 microns thick.

As illustrated in FIG. 11, an optical beam emitted by laser 970 passes through layers 914, 918, 922, 926, 930 and 934 and is reflected by layer 938 and sensed by detector 972. A portion of an optical beam emitted by laser 970 passes through layers 914, 918, 922, 926, 930, 934, 938, 942, 946. 950, 954, 960 and 964, and is reflected by layer 968 to and sensed by detector 972. In the recording mode, the laser beam from laser 970 can be focused on the phase-change layer 926 or 954 to change its reflectivity properties similar to a conventional CD-RW, DVD-RW, DVD+RW or next generation of optical discs with playback laser wavelength at around 400 nm as disclosed, for example in U.S. Pat. Nos. 6,544,616, 6,652,948 and 6,649,241.

One embodiment of the invention as illustrated in FIG. 12 is an optical storage device 1010 of the Blu-ray configuration further including two write once layers 1048 and 1024. Optical storage device 1010 is a dual-layer write once recording medium including a 1.1 mm thick substrate layer 1060, adjacent to a reflective layer 1056 about 30 to 60 nm thick. Layer 1056 is adjacent to protective layer 1052, and layer 1052 is adjacent to a recordable layer 1048, 15 to 25 nm thick. Layer 1048 is adjacent to protective film layer 1044.

Layer 1044 is adjacent to a separation layer or spacer layer 1040, which is adjacent to a 10 nm thick semi-reflective layer 1034. Layer 1034 is adjacent to protective film layer 1030 which is adjacent to a second 10 nm thick recording layer 1024. Layer 1024 is adjacent to protective film 1020, which is adjacent to a 0.075 mm thick cover layer 1014.

As illustrated in FIG. 12, an optical beam emitted by laser 1070 passes through a lens system with NA 0.85 (not shown in FIG. 12) and through layers 1014, 1020, 1024 and 1030 and is reflected by the semi-reflective layer 1034 and sensed by detector 1072. A portion of an optical beam emitted by laser 1070 passes through layers 1014, 1020, 1024, 1030, 1034, 1040, 1044, 1048 and 1052, and is reflected by reflective layer 1056 and sensed by detector 1072. Detector 1072 senses modulations in light intensity based on the amorphous or the crystalline state of the layer 1024 or 1048 in a particular spot on semi-reflective layer 1034 and on the reflective layer 1056 and reads the stored information back by focusing laser light from laser 1070 on the write-once layer 1024 or 1048. The spacer layer 1040 should be thick enough so that when the read beam is focused on the recordable layer 1024, the read beam is sufficiently defocused on the next recordable layer 1048 and only the modulation of light information from 1024 is reflected back to the detector 1072. Conversely, when the read beam is focused on the recordable layer 1048, the read beam is sufficiently defocused on the other recording layer 1024 and only the modulation from 1048 is reflected to the detector 1072 and read.

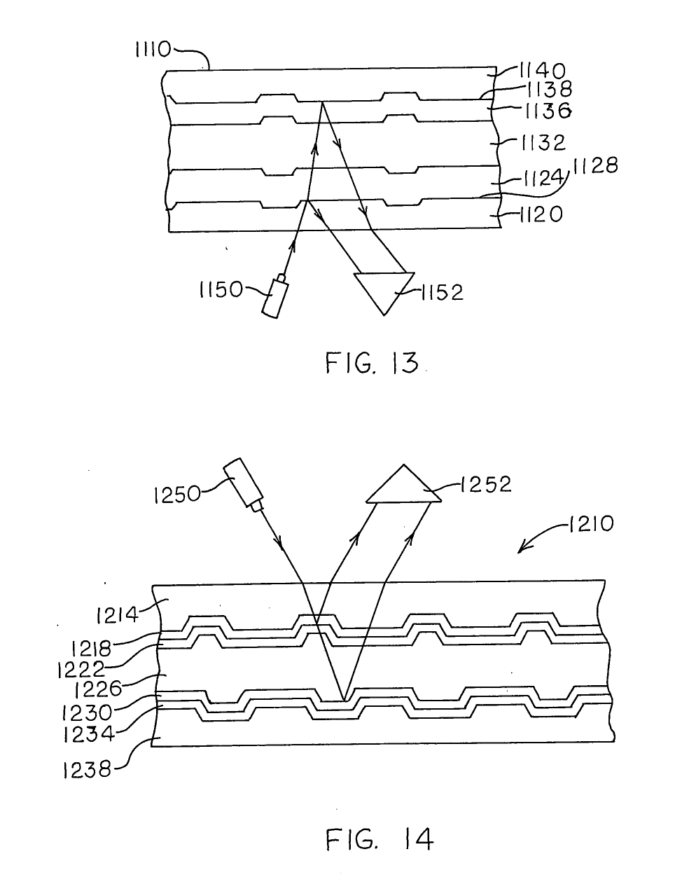

Another embodiment the invention, as illustrated in FIG. 13, is optical storage device 1110, which is a prerecorded HD DVD optical storage type device. HD DVD is a system that uses a 405 nm wavelength laser beam and a lens system with a NA of 0.65 to record and retrieve information for both faces of an optical storage device where the substrate layers 1120 and 1140 are about 0.6 mm thick.

Device 1110 includes substrate layer 1140 adjacent to a reflective layer 1136 which is adjacent to and conforms to the contours of a first data pit pattern 1138, including a set of pits and lands. Reflectivity layer 1136 is adjacent to spacer layer 1132 which is adjacent to a semi-reflective layer 1124, which is adjacent to and conforms to the contours of a second data pit pattern 1128, that includes a series of pits and lands. Layer 1124 is adjacent to a second substrate layer 1120.

As illustrated in FIG. 13, a portion of an optical beam emitted by laser 1150 passes through layers 1120, 1124, 1128 and 1132, and is reflected by the reflective layer 1136 and sensed by detector 1152. A portion of an optical beam emitted by laser 1150 passes through layers 1120, and is reflected by semi-reflective layer 1124 and sensed by detector 1152. Detector 1152 senses modulations in light intensity based on the presence or absence of a pit or land in a particular spot on semi-reflective layer 1124 and the reflective layer 1136 by focusing on layer 1124 or 1136.

It is understood that the disc structure as described in FIG. 12 can be modified so that both layers 1014 and 1060 can be of approximately the same thickness or around 0.6 mm and with similar phase-change material recording stack. The disc structure could be a rewritable optical disc of the HD DVD type wherein the recording and playback laser wavelength is around 400 nm.

In another embodiment the invention, illustrated in FIG. 14, an optical storage device 1210 of the organic dye recordable-dual-layer type includes two layers, which are both readable and recordable from the same side of the device. Device 1210 includes a substrate layer 1214 adjacent to first recordable dye layer 1218. Dye layer 1218 is adjacent to semi-reflective layer 1222. Layer 1222, sometimes called “Layer zero” or L0, is adjacent to spacer layer 1226. Spacer layer 1226 is adjacent to a second dye recording layer 1230. Layer 1230 is adjacent to reflective layer 1234. Reflective layer 1234, sometimes called “layer one” or L1, is adjacent to substrate layer 1238.

In write mode, as illustrated in FIG. 14, optical beam source 1250 emits a laser beam which passes through layers 1214, and is focused on dye layer 1218. When laser 1250 is operating at high intensity, the optical beam focused on layer 1218 decomposes the dye in layer 1218 creating a data pit pattern that includes the equivalent of a series of pits and lands. A portion of an optical beam emitted by laser 1250 passes through layers 1214, 1218, 1222 and 1226 and is focused on dye layer 1230. When laser 1250 is operating at high intensity, the optical beam focused on layer 1230 decomposes the dye in layer 1230 to create a data pit pattern that includes a series of pits and lands.

In read mode, a portion of an optical beam emitted by laser 1250 passes through substrate layer 1214 and dye layer 1218, is reflected by the semi-reflective layer 1222 and sensed by detector 1252. A portion of the optical beam also passes through layers 1214, 1218, 1222, 1226 and 1230 and is reflected by reflective layer 1234 and sensed by detector 1252. Detector 1252 senses modulations in light intensity based on the presence or absence of a pit or land in a particular spot on the reflective layer 1234 or by the semi-reflective layer 1222 depending on whether the laser light 1250 is focused on the semi-reflective layer 1222 or the reflective layer 1234. The general operation of an organic dye-based optical recording medium is disclosed in, for example, U.S. Pat. Nos. 6,641,889 and 6,551,682.

It is further understood that the optical disc structure as described in FIG. 14 can be a dual layer DVD-R or DVD+R disc where the playback laser beam has a wavelength of around 635 to 650 nm, or the structure can be a dual layer HD-DVD-R disc, where the playback laser has a wavelength around 400 nm or any other optical disc structure wherein two or more layers of information can all be recorded or played back from one side of the disc in which a semi-reflective layer or reflective layers are useful.

As used herein, the term “reflectivity” refers to the fraction of optical power incident upon substrate layer 14, 114, 214, 314, 414 or 514 which, when focused to a spot on a region of layer 20, 120, 216, 220, 316, 320, 324, 422 or 522 could in principle, be sensed by a photodetector in an optical readout device. It is assumed that the readout device includes a laser, an appropriately designed optical path, and a photodetector, or the functional equivalents thereof.

It is further understood that the optical disc structures described in FIGS. 8, 9, 10 and 13 can contain a dual layer disc structure of the prerecorded type where the playback laser beam has a wavelength of around 635 to 650 nm as in FIGS. 7 and 8, or contain a dual layer HD-DVD disc structure wherein the playback laser has a wavelength around 400 nm or any other optical disc structure with two or more layers of information all recorded or played back from one side of the disc.

It is also understood that as described in FIGS. 11 and 12, a dual layer disc of the write-once or a rewritable type with a phase change recording layer or other types of recording layers can be constructed that at least two recording layers can be recorded and read from one side or the same side of the disc, wherein a semi-reflective layer made with silver alloy of the current invention can be utilized and made useful.

Having presented the preceding compositions for the thin film materials, it is important to recognize that both the manufacturing process of the sputtering target and the process to deposit the target material into a thin film, play important roles in determining the final properties of the film. As such, one method of making the sputtering target will now be described. In general, vacuum melting and casting of the alloys or melting and casting under protective atmosphere, are done to minimize the introduction of other unwanted impurities.

Afterwards, the as-cast ingot should undergo a cold or hot working process to break down the segregated and the non-uniform as-cast microstructure. One method is cold or hot forging or cold or hot uni-axial compression with a more than 50 percent size reduction, followed by annealing to recrystallize the deformed material into fine equi-axed grain structure, which can be a texture of <1,1,0> orientation. This texture can promote directional sputtering in a sputtering apparatus so that more of the atoms from the sputtering target will be deposited onto the disc substrates for more efficient use of the target material.

Alternatively, a cold or hot multi-directional rolling process with more than a 50 percent size reduction can be employed, followed by annealing, to promote a random oriented microstructure in the target followed by machining the target to a final shape and size suitable for a given sputtering apparatus. A target, with a more random crystal orientation, will eject atoms more randomly during sputtering, and will produce a disc substrate with a more uniform distribution and thickness.

Depending on the application, different discs' optical and other system requirements, either a cold or hot forging or a cold or hot multi-directional rolling process can be employed in the target manufacturing process to optimize the optical and other performance requirements of the thin film for use in a given application.

The elements, compounds and/or alloys used to make the reflective thin film of the invention can be deposited using well-known methods including, but not limited to sputtering, thermal evaporation, physical vapor deposition, or electrolytic or electroless plating processes. The thin film's reflectivity can vary depending on the method of application. Any application method that adds impurities to, or changes the surface morphology of, the reflective thin film layer on the disc could conceivably, lower the reflectivity of the layer, but to a first order of approximation, the reflectivity of the reflective thin film layer on the optical disc is primarily determined by the starting material of the sputtering target, evaporation source material, or the purity and composition of the electrolytic and electroless plating chemicals used.

Vacuum evaporation can be applied using an arrangement in which an evaporation source and substrates layer according to the invention is opposite to the evaporation source in a vacuum vessel. This technique can be used to form films of a metal, metal compound and/or metal alloy on the respective surfaces of present substrate layers by depositing particles of the metal compound and/or metal alloy on the respective surfaces of the substrate layers through evaporating the metal particles from the evaporation source by means of electron beam heating or resistance heating. The substrate layers can be generally mounted on rotary holders. The evaporation source can have a large number of tungsten heaters stretched between two props, and a large number of evaporation materials attached thereto, so that the respective evaporation materials are evaporated through heat generated by energizing the respective tungsten heaters.

Plasma sputtering can be used in an arrangement in which a sputtering source (for example, magnetron type sputtering source) having a metal, metal compound and/or metal alloy target attached to the upper portion of a magnet and substrate layers according to the invention opposite to the sputtering source are provided in a vacuum vessel. This technique forms films of a metal, metal compound and/or metal alloy on the respective surfaces of the substrate layers by depositing metal particles on the respective surfaces of the substrate layers through sputtering the metal target through plasma generated between the sputtering source and the respective substrate layers by a magnetic field formed in the neighborhood of the surface of the metal target, an electric field applied between the respective substrate layers and the metal target in the vacuum vessel in which an inert gas, such as argon gas, is introduced. Methods for sputtering metal films are disclosed in U.S. Pat. Nos. 5,431,794 and 5,283,095, the relevant portions of which are incorporated herein by reference.

It should be understood that the multilayer structure of this invention can be used for future generations of optical discs that use a reading laser of a shorter wavelength, for example, a reading laser with a wavelength of 650 nanometers or shorter.

A particular embodiment of the invention provides an optical storage medium that includes:
a substrate layer containing a compounded interpenetrating polymer network containing from about 60 to about 99.9 weight percent of one or more copolymers containing polymerized residues from one or more styrenic monomers and one or more C₁-C₃₂ linear, branched, or cyclic alkyl(meth)acrylate monomers and/or maleic-type monomers, and from about 0.1 to about 40 weight percent of one or more elastomeric materials containing polymerized residues from one or more styrenic monomers and one or more diene monomers, where the refractive index of the copolymers and the refractive index of the elastomeric materials are within 0.01 refractive index units of each other; and
a reflective metal film layer sputtered on a surface of the substrate layer, where the metal film layer contains aluminum and/or silver; and where the optical storage medium includes a storage methodology selected from the group consisting of a pattern of features in at least one surface of the substrate layer, an optically recordable dye layer adjacent to the reflective layer, and a layer comprising an optically re-recordable material.

Another particular embodiment of the invention provides an optical storage medium that includes:
a substrate layer containing a material prepared by polymerizing a mixture that includes:
   about 60 to about 99.9 weight percent of a monomer mixture containing at least 60 weight percent of one or more styrenic monomers and up to 40 weight percent of one or more C₁-C₃₂ linear, branched, or cyclic alkyl(meth)acrylate monomers and/or maleic-type monomers; and
   about 0.1 to about 40 weight percent of one or more elastomeric materials containing polymerized residues from one or more styrenic monomers and one or more diene monomers;
   where the refractive index of the copolymers from the monomer mixture and the refractive index of the elastomeric materials are within 0.01 refractive index units of each other; and
a reflective metal film layer sputtered on a surface of the substrate layer, where the metal film layer contains aluminum and/or silver.

The present invention will further be described by reference to the following example. The following example is merely illustrative of the invention and is not intended to be limiting. Unless otherwise indicated, all percentages are by weight.

### EXAMPLE

Discs were molded using a resin composition prepared according to Example 2 of United States Patent Application Publication 2006/0100371. Specifically, the resin was an approximately 80/20 w/w blend of a 70/30 w/w copolymer of styrene and methyl methacrylate available as NAS 30 (NOVA Chemicals Inc., Pittsburgh, Pa.) and a 62/38 w/w block copolymer of styrene and butadiene as described in Example 1 of US Publication 2006/0100371.

The discs were molded using a SD30 disc molding machine (Sumitomo Plastics Machinery, Norcross, Ga.) utilizing a J-type mold (Seikoh Giken, USA, Inc., Norcross, Ga.).

Aluminum was deposited by sputtering on the molded disks.

The information molded into the discs is readable by a conventional device for reading compact disks.

The present invention has been described with reference to specific details of particular embodiments thereof. It is not intended that such details be regarded as limitations upon the scope of the invention.

What is claimed is:

1. A multilayer structure comprising:
a substrate layer comprising a mixture containing
one or more copolymers comprising polymerized residues from one or more styrenic monomers and one or more C₁-C₃₂ linear, branched, or cyclic alkyl(meth)acrylate monomers and/or maleic-type monomers, and
one or more elastomeric materials; and
a reflective film layer coated on a surface of the substrate layer.

2. The multilayer structure according to claim 1, wherein the mixture comprises from 60 to 99.9 weight percent of the copolymers and from 0.1 to 40 weight percent of the elastomeric materials.

3. The multilayer structure according to claim 1, wherein the styrenic monomers are selected from the group consisting of styrene, p-methyl styrene, α-methyl styrene, tertiary butyl styrene, dimethyl styrene, nuclear brominated or chlorinated derivatives thereof and combinations thereof.

4. The multilayer structure according to claim 1, wherein the alkyl(meth)acrylate monomers are selected from the group consisting of methyl(meth)acrylate, ethyl(meth)acrylate, n-propyl(meth)acrylate, isopropyl(meth)acrylate, n-butyl(meth)acrylate, isobutyl(meth)acrylate, hexyl(meth)acrylate, decyl(meth)acrylate, dodecyl(meth)acrylate, octadecyl(meth)acrylate and combinations thereof.

5. The multilayer structure according to claim 1, wherein the maleic-type monomers are selected from the group consisting of maleic anhydride, maleic acid, fumaric acid, C₁-C₁₂ linear, branched or cyclic alkyl esters of maleic acid, C₁-C₁₂ linear, branched or cyclic alkyl esters of fumaric acid, itaconic acid, C₁-C₁₂ linear, branched or cyclic alkyl esters of itaconic acid, itaconic anhydride and combinations thereof

6. The multilayer structure according to claim 1, wherein the elastomeric materials are selected from the group consisting of homopolymers of butadiene or isoprene, and random block, AB diblock, ABA triblock, or multi-block copolymers of a conjugated diene with one or monomers selected from the group consisting of styrenic monomers, (meth)acrylonitrile, C₁-C₃₂ linear, branched, or cyclic alkyl(meth)acrylate monomers and combinations thereof

7. The multilayer structure according to claim 6, wherein the multi-block copolymers are selected from the group consisting of star copolymers, comb copolymers and branched copolymers.

8. The multilayer structure according to claim 1, wherein the elastomeric materials include one or more block copolymers selected from the group consisting of diblock and triblock copolymers of styrene-butadiene, styrene-butadiene-styrene, styrene-isoprene, styrene-isoprene-styrene, partially hydrogenated styrene-isoprene-styrene.

9. The multilayer structure according to claim 1, wherein the elastomeric materials include one or more SBC resins comprising from 10 to 80 weight percent butadiene and/or other conjugated diene units and from 20 to 90 weight percent styrenic monomer units.

10. The multilayer structure according to claim 1, wherein the refractive index of the copolymers and the refractive index of the elastomeric materials are within 0.01 refractive index units of each other.

11. The multilayer structure according to claim 1, wherein the mixture is prepared by physically blending and/or compounding the copolymers and the elastomeric materials.

12. The multilayer structure according to claim 11, wherein the mixture is a compounded interpenetrating polymer network of the copolymers and the elastomeric materials.

13. The multilayer structure according to claim 1, wherein the mixture is prepared by polymerizing a monomer mixture comprising one or more styrenic monomers and one or more C₁-C₃₂ linear, branched, or cyclic alkyl(meth)acrylate monomers and/or maleic-type monomers in the presence of one or more elastomeric materials.

14. The multilayer structure according to claim 13, wherein the styrenic and (meth)acrylate monomers and/or maleic-type monomers and polymers formed therefrom comprise a continuous phase and the elastomeric polymers comprise a dispersed phase having a particle size of from about 0.1 microns to about 11 microns.

15. The multilayer structure according to claim 13, wherein at least 40 weight percent of the monomer mixture comprises one or more styrenic monomers.

16. The multilayer structure according to claim 1, wherein the substrate layer comprises a blend containing at least 50 weight percent of the mixture and one or more materials selected from the group consisting of polycarbonates, poly(meth)acrylates, polyamides, polyesters and combinations thereof.

17. The multilayer structure according to claim 1, wherein the reflective film layer comprises a metal film.

18. The multilayer structure according to claim 17, wherein the metal film comprises one or more elements selected from the group consisting of Al, Se, Ti, V, Mn, Fe, Co, Ni, Cr, Cu, Zn, Ga, Sn, Pd, Pt, Au, Ag, In, Sb, Te, W, Ta, Mg, O, B, N, C, P, Si and compounds containing combinations thereof.

19. The multilayer structure according to claim 17, wherein the metal film comprises one or more elements selected from the group consisting of Al, Au, As, In, Sb, Te, Cr, Ge, Sb, Tb, Fe, Co Bi and compounds containing combinations thereof.

20. The multilayer structure according to claim 17, wherein the metal film comprises a metal alloy containing silver, copper, and an element selected from the group consisting of cadmium, lithium, indium, chromium, antimony, gallium, germanium, boron, molybdenum, zirconium, and beryllium.

21. The multilayer structure according to claim 17, wherein the metal film comprises aluminum.

22. The multilayer structure according to claim 17, wherein the metal film is applied to the substrate layer using a sputtering process.

23. An optical storage medium comprising the multilayer structure according to claim 1.

24. The optical storage medium according to claim 23, wherein the substrate layer contains a pattern of features in at least one surface.

25. The optical storage medium according to claim 24, wherein the pattern of features includes a spiral groove.

26. The optical storage medium according to claim 23 comprising an optically recordable dye layer adjacent the reflective layer.

27. The optical storage medium according to claim 23 comprising a layer comprising an optically re-recordable material.

28. The optical storage medium according to claim 23, wherein the optically re-recordable material comprises a magneto-optic material.

29. An optical storage medium comprising
a substrate layer comprising a compounded interpenetrating polymer network comprising from about 60 to about 99.9 weight percent of one or more copolymers comprising polymerized residues from one or more styrenic monomers and one or more C₁-C₃₂ linear, branched, or cyclic alkyl(meth)acrylate monomers and/or maleic-type monomers, and from about 0.1 to about 40 weight percent of one or more elastomeric materials comprising and polymerized residues from one or more styrenic monomers and one or more diene monomers, wherein the refractive index of the copolymers and the refractive index of the elastomeric materials are within 0.01 refractive index units of each other; and
a reflective metal film layer sputtered on a surface of the substrate layer, wherein the metal film layer comprises aluminum and/or silver;
wherein the optical storage medium includes a storage methodology selected from the group consisting of a pattern of features in at least one surface of the substrate layer, an optically recordable dye layer adjacent the reflective layer, and a layer comprising an optically re-recordable material.

30. An optical storage medium comprising
a substrate layer comprising a material prepared by polymerizing a mixture comprising
about 60 to about 99.9 weight percent of a monomer mixture containing at least 60 weight percent of one or more styrenic monomers and up to 40 weight percent of one or more C₁-C₃₂ linear, branched, or cyclic alkyl(meth)acrylate monomers and/or maleic-type monomers; and
about 0.1 to about 40 weight percent of one or more elastomeric materials comprising polymerized residues from one or more styrenic monomers and one or more diene monomers;
wherein the refractive index of the copolymers from the monomer mixture and the refractive index of the elastomeric materials are within 0.01 refractive index units of each other; and
a reflective metal film layer sputtered on a surface of the substrate layer, wherein the metal film layer comprises aluminum and/or silver.
